(19) United States
(12) Patent Application Publication
(10) Pub. No.: US 2005/0147530 A1
(43) Pub. Date: Jul. 7, 2005

(54) Method and detector for identifying effective lifetime of gas scrubber absorbent material, and gas scrubber including the detector

(76) Inventors: Hyoung-Don Kang, Gyeonggi-do (KR); Jin-Seok Park, Gyeonggi-do (KR); Dong-Kyu Lee, Gyeonggi-do (KR); Do-Hyun Cho, Gyeonggi-do (KR); Pil-Weon Kim, Gyeonggi-do (KR); Jong-Ryeol Hur, Gyeonggi-do (KR)

Correspondence Address: MARGER JOHNSON & MCCOLLOM, P.C., 1030 SW MORRISON STREET, PORTLAND, OR, 97205, US

(21) Appl. No.: 10/924,744

(22) Filed: Aug. 23, 2004

(30) Foreign Application Priority Data
Aug. 22, 2003 (KR) 2003-58250

(51) Int. Cl. G01N 31/22

(52) U.S. Cl. 422/56; 422/119

(57) ABSTRACT

Provided is a detector, a gas scrubber comprising the detector for identifying a residual lifetime of an absorbent material contained in a gas scrubber for purifying a harmful exhaust gas, and a method of identifying the residual lifetime of the absorbent material. The detector comprises a solid chemical material, the color of which changes when it comes in contact with the untreated exhaust gas due to loss of absorbing power of the absorbent material, a detection window containing the solid chemical material therein, therethrough the visual identification of the color change of the solid chemical material can be made, and connecting units placed on an upper and lower end of the detection window. The visual identification of the color change of the solid chemical material through the detection window enables the continuous and safe identification of the residual lifetime of the absorbent material and the replacement time, thereby increasing the reliability of the gas scrubber.

### BACKGROUND OF THE INVENTION

This application claims the priority of Korean Patent Application No. 2003-58250, filed on Aug. 22, 2003 in the Korean Intellectual Property Office, the disclosure of which is incorporated herein in its entirety by reference.

1. Field of Invention

The present invention relates to a method and a detector for identifying the effective lifetime of an absorbent material in a gas scrubber, and to a gas scrubber including the detector, and more particularly, to a method and a detector for identifying the effective lifetime of the absorbent material to purify a harmful exhaust gas generated in a semiconductor manufacturing process, and to the gas scrubber including the detector.

2. Description of the Related Art

Gas generated during a semiconductor manufacturing process contains flammable and/or corrosive components, which make the gas very harmful to the human body and the environment. Therefore, the gas should be treated and made chemically safe before exhausting it to the atmosphere.

Process gases used in the semiconductor manufacturing process, such as SiH₄, NH₃, and AsH₃ are flammable, explosive, and very toxic. However, a significant amount of these harmful gases are exhausted from a process chamber without reaction during the semiconductor manufacturing process. Therefore, these gases should be treated for safety purposes before discharging them into the atmosphere. A gas scrubber performs a cleaning function for these gases.

Since the process gases remaining in the chamber after finishing the semiconductor manufacturing process, and the cleaning gas used for cleaning the residual powder in the chamber, are harmful acidic gases, the harmful components in these gases should be removed before discharging them into the air from a gas scrubber. Examples of the cleaning gases include NF₃ and HF.

The gas scrubber is a device for treating an exhaust gas generated in the semiconductor manufacturing process. Conventionally, the gas scrubber, depending on the gas treatment method, is classified into three types as follows: a wet type gas scrubber, a combustion type gas scrubber, and an absorption type gas scrubber.

The wet type gas scrubber neutralizes the exhaust gas using a washing liquid and then absorbs the treated gas. The wet type gas scrubber is suitable for treating a large volume gas, but has a disadvantage of incomplete treatment of insoluble gases, and requires an extra cost for a wastewater treatment.

The combustion type gas scrubber burns and decomposes the exhaust gas at a high temperature. It also has the advantage of being able to handle a large capacity. However, it also requires an extra cost for treating any harmful by-products.

The absorption type gas scrubber uses an absorbent material to remove harmful components by absorption. In the absorption type gas scrubber, the absorbent material is filled in a canister that is disposed in the gas scrubber to remove harmful gas. The absorbent material purifies the harmful gas used in the semiconductor manufacturing process by absorbing it physically and chemically. Materials that can be used as absorbent are active carbon and basic materials such as NaOH, Ca(OH)₂, Mg(OH)₂, and the like. In recent years, a chemical resin is widely used an absorbent material.

An important aspect of the absorption type gas scrubber is the identification of the residual lifetime and the replacement time of the absorbent material. After a continuous usage of the absorbent material in the canister, the absorbent material no longer absorbs the harmful gas due to loss of absorbing power. Accordingly, the absorbent material in the canister must be replaced with new material in order to clean the exhaust gas. For purposes of determining the replacement time of the absorbent material, there are generally three methods. The first method is the measurement of a weight change of the canister in a gas scrubber. The second method is the detection of a temperature change caused by absorption heat generated when the absorbent material adsorbs the harmful gas. The third method is using a gas detector of an electrolyte type.

In relation to the the second method, Korean Laid-Open patent Publication No. 2002-0034406 has proposed a method of identifying the residual lifetime and the replacement time of an absorbent material by detecting the absorption heat using temperature sensors installed in the upper, middle, and lower part of a canister. This method is based on the theory that no absorption heat is generated when the absorbing power of the absorbent material in the canister is depleted. Then, there are no temperature changes in the upper, middle, and lower part of the canister. In this method, however, since the residual lifetime of the absorbent material according to the temperature change cannot be confirmed correctly, there is a difficulty in determining the exact time to replace the absorbent material.

For the absorption type gas scrubber used in recent years, an electrolyte type gas detector is widely adapted for identifying the lifetime of the absorbent material in the canister. In this method, the residual lifetime and the replacement time are identified by monitoring the concentration of harmful components in the exit gas by the electrolyte type gas detector. In other words, when the concentration of the harmful component in the exit gas is larger than a predetermined value, the color of the electrolyte in the gas detector is changed by reaction with the exhaust gas. This change of color is transmitted to a control unit by a sensor, and then the control unit releases a warning alarm that the life time of the absorbent material has been exceeded, thereby informing a operator that the absorbent material in the canister has to be replaced.

FIG. 1 is a general view of a gas scrubber system having a conventional electrolyte type gas detector. Referring to FIG. 1, an exhaust gas from a chemical vapor deposition (CVD) process, a dry etching process, or a diffusion process enters into a gas scrubber 100. A canister 10 is installed in an enclosing cabinet 14 of the gas scrubber 100. The absorbent material fills the canister 10 that purifies the gas by absorbing the harmful gaseous material physically and chemically. The exhaust gas then passes through the absorbent material in the canister 10 and enters into an electrolyte type gas detector 12 through a bypass pipeline. The gas detector 12 monitors the concentration of the harmful components in the gas (which has passed through the absorbent material). If the concentration of the harmful component in the gas is greater than a predetermined value, which indicates that the lifetime of the absorbent material has expired, the color of the electrolyte in the gas detector 12 changes. The information of the color change is converted into an electrical signal by a sensor installed in the gas detector 12, and then the electrical signal is transmitted to a control unit 16. The control unit 16 transfers the signal to an alarm device 18 based on the electrical signal received from the sensor. Then, the alarm device generates a warning alarm. The same purifying mechanism of the gas scrubber is applied to the cleaning gas purification.

However, the electrolyte type detector does not inform an operator of the residual lifetime of the absorbent material instantly and continuously. That is, this method informs the operator of the residual lifetime of the absorbent material by transmitting a single warning sound when the replacement time is reached. Therefore, if the operator does not hear a warning sound, confirmation of the loss of absorbing power of the absorbent material does not occur. Accordingly, the gas scrubber is operated without replacing the inactive absorbent material, which can cause environmental problems.

Also, due to the volatility of the electrolyte in the detector, the detector should be replaced periodically even though it has not been used. That is, regardless of the operation of the gas scrubber, the electrolyte in the detector cannot be used after a certain period of time (normally 6 months) because of its volatility. Therefore, the absorbing power of an absorbent material should be maintained by periodically replacing the detector, which is very costly since the replacement process is very complicated.

Owing to these problems, and from a practical standpoint, the detector cannot be replaced in a timely, periodic manner. Thus, the absorbent material in the gas scrubber loses its power, which results in the environmental contamination due to the escape of harmful gas. That is, when the user misses the warning sound of the detector, or if periodical replacement of the detector is not performed, the process will not operate so that the absorbent material has enough absorbing power. Accordingly, a harmful gas will be discharged without cleaning.

### SUMMARY OF THE INVENTION

To solve the above problems, the present invention provides a gas scrubber including a detector for identifying the residual lifetime of an absorbent material.

The present invention further provides a method of visually identifying the residual lifetime and replacement time of an absorbent material instantly and continuously.

In accordance with an aspect of the present invention, the detector for identifying the residual lifetime of an absorbent material includes, a solid chemical material, the color of which changes when it comes in contact with an untreated exit gas due to loss of absorbing power of the absorbent material, a detection window which contains the solid chemical material, and through which the color change of the solid chemical material can be visually detected from a location outside the gas scrubber with bare eyes. A connecting unit may be placed on the upper and lower part of the detection window.

The detection window of the detector can be formed of a material strengthened to withstand the pressure of a gas passing through the detector, such as a strengthened glass.

The solid chemical material in the detection window can contain a metal component, the color of which changes when the metal contacts the untreated flammable gas and the gas. The solid chemical material can also contain a metal oxide in which manganese is the main component. Also, the solid chemical material contained in the detection window is formed of a plurality of particles that can be visually identified. Preferably, the average diameter of the particles is about 2.0 mm and the average length is about 7 mm. Also, it is preferable that the average specific surface of the solid chemical material is about 170 m²/g, the average specific volume of pores is about 0.9 cc/g, and the average density is about 0.73 g/cc.

In accordance with another aspect of the present invention, a gas scrubber includes an canister for purifying the process gas or cleaning the gas, and a detector for identifying the residual lifetime of the absorbent material contained in the absorbent canister. The detector for detecting the residual lifetime of the absorbent material includes a solid chemical material, the color of which changes when it reacts with untreated exhaust gas discharged due to loss of the absorbing power of the absorbent material, a detection window, which contains the solid chemical material, through which the color change of the solid chemical material can be visually detected from the outside, and connecting units placed on the upper and lower part of the detection window.

The gas scrubber may include pipelines connecting the front end and rear end of the absorbent canister, and the front end and rear end of the detector. Also, the gas scrubber may further include an enclosing cabinet. In this case, the detector is installed in the enclosing cabinet, and a viewing window can be placed on the surface of the enclosing cabinet to detect therethrough the color change of the solid chemical material in the detector from the outside of the cabinet. However, for an easy detection of the color change of the absorbent material by a scrubber operator, the detector can be installed outside of the enclosing cabinet of the gas scrubber.

Also, the above gas scrubber can include a camera for taking pictures of the solid chemical material in the detector. The gas scrubber further includes a display device for connecting the camera. In this case, the pictures are shown on the displaying device to allow the scrubber operator to observe the color change of the solid chemical material. Also, the gas scrubber further comprises a brightness sensor for detecting the brightness of the solid chemical material in the detector. In addition, the gas scrubber further comprises a control unit for determining the residual lifetime and the replacement time of the absorbent material by comparing a brightness value with a predetermined value. The brightness value is obtained by digitalizing of a signal transmitted from the brightness sensor by the control unit. The control unit is connected to the display device to display the brightness value data. When the measured brightness value falls below the predetermined value, the control unit makes the alarm device release a warning alarm.

In accordance with another aspect of the present invention, a method of identifying the residual lifetime of an absorbent material in a gas scrubber comprises the steps of inducing an exhaust gas, which has passed through an absorbent canister in the gas scrubber, to a detector for identifying the residual lifetime of the absorbent material, and detecting the color change of a solid chemical material in the detector through a detection window.

In this case, the color change of the solid chemical material can be visually detected through the detection window. Also, when the detector is enclosed with an enclosing cabinet, the color change of the solid chemical material can be detected by visually observing the solid chemical material through the viewing window placed on the surface of the enclosing cabinet.

As another way of identification of the residual lifetime of the absorbent material, the detection of the color change of the solid chemical material through the detection window can be made by observing pictures of the solid chemical material obtained by a camera disposed in the gas scrubber. In this case, the pictures can be displayed on a display device that is connected to the camera.

Also, as another method of identifying the residual lifetime of the absorbent material, the color change of the solid chemical material through the detection window can be detected by a brightness sensor installed in the gas scrubber and a control unit connected to the brightness sensor. In this case, the control unit digitizes a brightness signal transmitted from the brightness sensor into a brightness value, and then the brightness value is compared with a predetermined value identify the residual life time and the replacement time of the absorbent material. The control unit is connected to the display device to display the brightness value data. Since the control unit is also connected to the warning device, the control unit makes the alarm device release a warning alarm when the measured brightness value falls below the predetermined value.

### BRIEF DESCRIPTION OF THE DRAWINGS

FIG. 1 is a general view of an absorption type gas scrubber having a conventional electrolyte type gas detector.

FIG. 2 is a perspective view of a detector for identifying the residual lifetime of an absorbent material, according to an embodiment of the present invention.

FIG. 3 is a perspective view of a gas scrubber having a detector for identifying the residual lifetime of an absorbent material, according to an embodiment of the present invention.

FIG. 4 is a schematic view of a gas scrubber according to an embodiment of the present invention.

FIG. 5 is a schematic view of a gas scrubber according to another embodiment of the present invention.

FIG. 6 is a schematic view of a gas scrubber according to another embodiment of the present invention.

FIG. 7 is a schematic view of a gas scrubber according to another embodiment of the present invention.

FIG. 8 is a schematic view of a gas scrubber for a semiconductor manufacturing facility using a detector, according to an embodiment of the present invention.

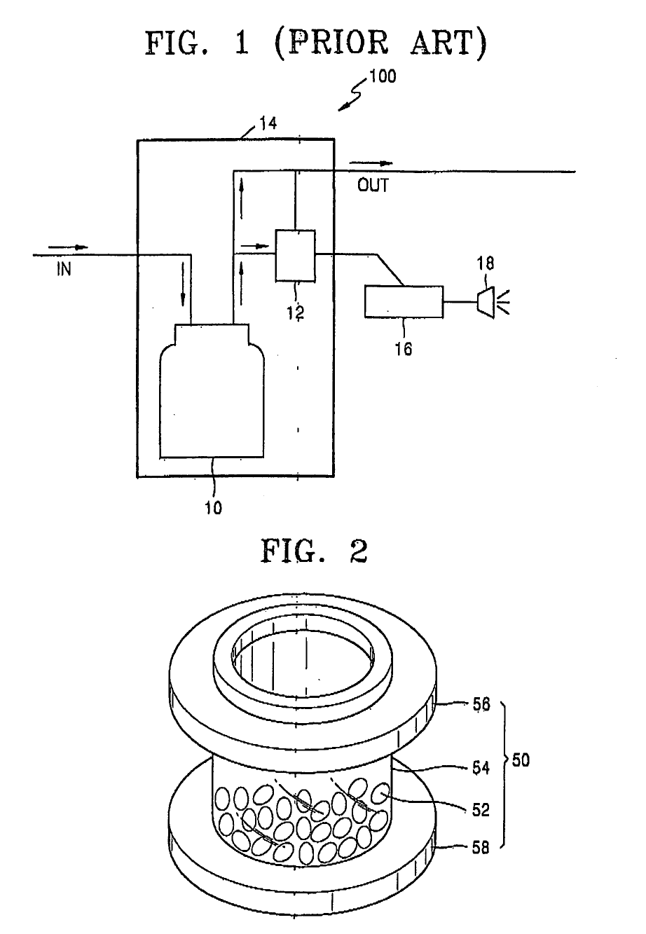

### DETAILED DESCRIPTION OF THE INVENTION

Hereinafter, the present invention will be described more fully with reference to the accompanying drawings. However, this invention may be embodied in many different forms and should not be construed as being limited to the embodiments set forth herein. Rather, theses embodiments are provided so that this disclosure is thorough and complete and fully conveys the concept of the invention to those skilled in the art.

Referring to FIG. 2, a detector 50 is filled with a solid chemical material 52 including a plurality of solid particles. The detector 50 has a transparent detection window 54 for visually observing the solid chemical material 52. The solid chemical material 52 is a chemical material for monitoring a harmful component contained in an exhaust gas that passes through a purifying absorbent. The role of detection window 54 is to allow an operator to observe the solid chemical material 52 from the outside and to act a sidewall of a container for the solid chemical material 52 located therein. Also, the detector 50 is equipped with connecting units 56 and 58 for connecting to pipelines or other parts on the upper end or lower end of the detector 50. The lower connecting unit 58 located on the lower end of the detector is connected to the exit pipeline of the absorbent canister (not shown). The lower connecting unit 58 located on the lower end could also be directly connected to a connecting unit (not shown) of the exit of the absorbent canister. The exhaust gas passed through the absorbent canister flows upward toward the upper end of the detector 50 through the lower end of the detector 50 and inside of the detection window.

The detection window of the detector 50 depicted in FIG. 2 has a cylindrical shape, but it could have an alternative configuration such as a square shape or an octagonal shape. The material for the detection window can be any material that is transparent and strong enough to withstand the pressure of the exhaust gas. However, considering manufacturing cost and efficiency, transparent glass is preferably employed. For safety purpose, strengthened glass, which can withstand the pressure of the exhaust gas passing through the detector 50, is particularly preferable for the material of the detection window 54.

The solid chemical material in the detector 50 is for monitoring harmful chemicals. The color of the solid chemical material is changed when it comes in contact with untreated harmful exhaust gas. If the harmful components in the process gas or cleaning gas were removed by passing through the absorbent material in the gas scrubber, the purified exhaust gas does not change the color of the solid chemical material in the detector 50. However, if the absorbent material in the gas scrubber exceeded its lifetime and lost the absorbing power, then a significant amount of harmful components could be included in the exhaust gas, thereby resulting in the color change of the solid chemical material. Accordingly, the absorbing power of the absorbent material can be monitored. The solid chemical material can help monitor not only the harmful gas having flammable components such as SiH₄, NH₃, and AsH₃, but also the harmful gas containing acidic components such as NF₃ and HF.

The color of the solid chemical material may be slowly changed from the lower end toward upward with the decrease in the absorbing power of the absorbent material. If the absorbent material loses substantially completely its absorbing power due to exceeding its lifetime, the color of the solid chemical material turns into a strong color shade. As the absorbing power of the absorbent material decreases, the color change of the solid chemical material diffuses gradually from the lower end toward upward and the degree of color becomes stronger. According to an embodiment of the present invention, the color of the solid chemical material turns into a low brightness color such as grey when it reacts with the harmful gas, and the brightness of the color is further lowered as the absorbent material loses its absorbing power. Therefore, the detector according to an embodiment of the present invention enables a continuous detection of the residual lifetime of the absorbent material.

The solid chemical material in the detector 50 contains metal components, the color of which changes when the absorbent material comes in contact with a flammable and acidic gas. Preferably, a metal oxide containing manganese as the main component is used in the solid chemical material. Preferably, the solid chemical material is formed of small solid particles having an average diameter of about 2.0 mm and an average length of about 7 mm. Also, preferably, the average specific surface of the particles is about 170 m²/g, and the average density is about 0.73 g/cc. Particles have small pores on their surface, and preferably, the specific volume of the pores is about 0.9 cc/g.

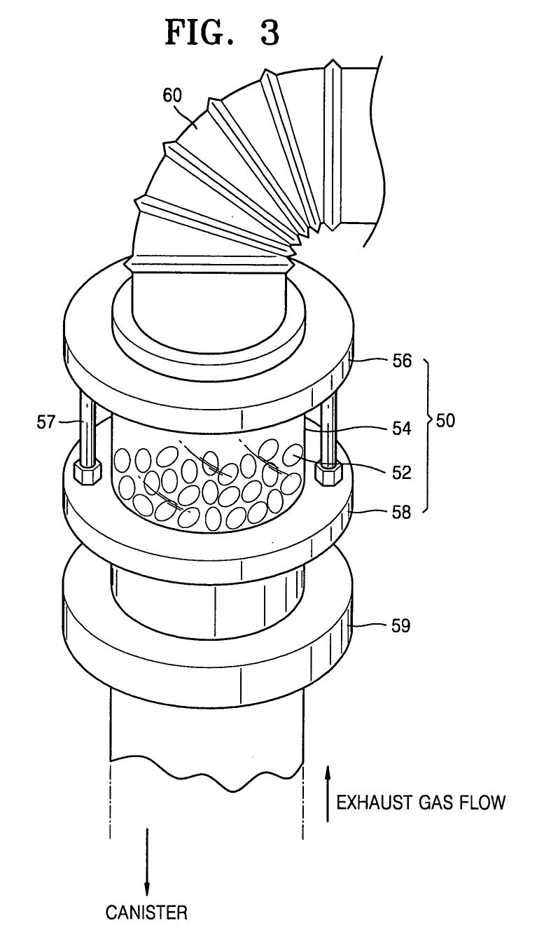

FIG. 3 is a perspective view of a gas scrubber system having the detector 50 for identifying the residual lifetime of an absorbent material, according to the embodiment of the present invention. Referring to FIG. 3, the detector 50 for identifying the residual lifetime of the absorbent material is connected to a pipeline 60 and to a connecting unit 59 of an exit of an absorbent canister. That is, the connecting unit 56 placed on the upper end of the detector 50 is connected to the pipeline 60, and the connecting unit 58 placed on the lower end of the detector 50 is connected to the connecting unit 59 of the absorbent canister exit (not shown). A detection window 54, which contains the solid chemical material, is placed between the upper and the lower connection units 56 and 58 for inducing the exit gas from the absorbent canister toward the solid chemical material 52. Any color change of the solid chemical material can be detected through the transparent detection window 54. In one embodiment of the present invention, a plurality of supporting bars 57 may be installed between the upper and lower connecting units 56 and 58 to support the static load exerted by the upper unit.

When the color of the solid chemical material changes substantially completely, the absorbent material must be replaced. In this case, the solid chemical material should also be replaced for continuous monitoring of the new absorbent material. The replacement of the solid chemical material with a new one can be simply conducted by dismantling the connecting units 56 and 58. The cost of the solid chemical material used for the detector according to an embodiment of the present invention is significantly lower than the cell cost of the conventional electrolyte type detector.

Moreover, in the conventional electrolyte type detector, the electrolyte in a cell has to be replaced at least twice a year due to the volatility of the electrolyte, even if a scrubber has not been operated. However, the solid chemical material in the detector according to an embodiment of the present invention does not need to be replaced if it has not been operated. The solid chemical material needs to be replaced when the color of the solid chemical material has changed completely after lifetime of the absorbent material exceeds. Accordingly, the use of a detector according to an embodiment of the present invention reduces installation costs during replacement of the chemicals compared to the conventional electrolyte type detector.

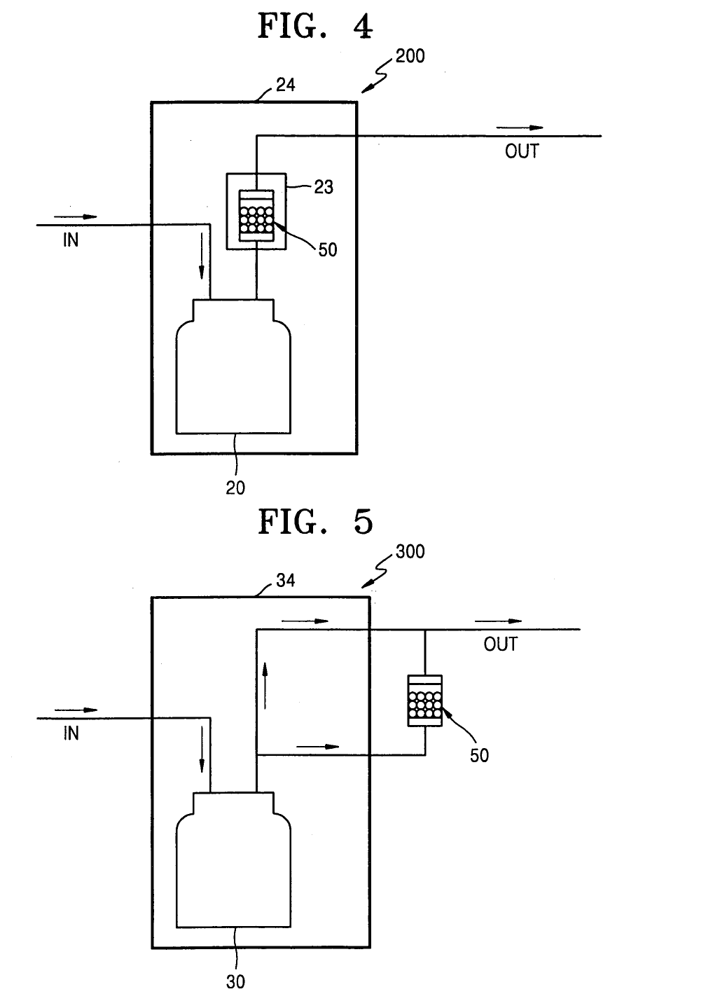

Hereinafter, referring to the FIGS. 4 through 7, a gas scrubber according to the embodiments of the present invention will be described. The gas scrubber uses the detector for identifying the residual lifetime of an absorbent material described previously.

Referring to FIG. 4, exhaust gas from a CVD process, a diffusion process, a dry etching process, or cleaning work enters into a gas scrubber 200 through an inlet of the gas scrubber 200. The gas scrubber 200 comprises a canister 20 filled with an absorbent material for removing the harmful components of the incoming exhaust gas. Here, the exhaust gas passing through the canister 20 is a process gas or a cleaning gas. The process gas contains especially harmful flammable components and the cleaning gas contains especially harmful acidic components.

The exhaust gas passed through the canister 20 enters into a detector 50 for detecting the residual lifetime of the absorbent material. A solid chemical material for detecting the residual lifetime of the absorbent material is filled in the detector 50. Since the solid chemical material is stored in a detector having a transparent detection window, a color change of the solid chemical material can be detected through the detection window. The exhaust gas passed through the detector 200 is discharged to outside through an outlet. In this case, if the absorbing power of the absorbent material in the canister 20 is at a normal level, the harmful components in the exhaust gas can be removed by the absorbent material. Accordingly, the exhaust gas does not change the color of the solid chemical material in the detector 200. However, if the absorbing power of the absorbent material is lost to a certain degree, a significant amount of the harmful components remained in the exhaust gas even after the exhaust gas passed through the canister 20. Accordingly, the color of the solid chemical material changes from the lower end toward upward in the detection window. If the absorbing power of the absorbent material is completely lost, the color of the solid chemical material changes into a strong color. According to an embodiment of the present invention, the color of the solid chemical material may be changed to a darker color as the result of the reaction with the harmful component in the gas.

Also, in the present invention, the gas scrubber 200 comprises an enclosing cabinet 24 having a canister 20 and a detector 50 for identifying the residual lifetime of the absorbent material therein. A viewing window 23 is placed on the surface of the enclosing cabinet 24 to observe the solid chemical material in the detector 50 from outside. The color change of the solid chemical material in the detector 50 can be detected through this viewing window 23. However, the gas scrubber can be used without the enclosing cabinet 24.

The gas scrubber 300 depicted in FIG. 5 is the same gas scrubber 200 depicted in FIG. 4 except for the detector 50 being installed outside of an enclosing cabinet 34 and connected to a branched bypass pipeline. Referring to FIG. 5, a large amount of gas passed through a canister 30 is exhausted from the gas scrubber 300 through a main pipeline, while a portion of the gas enters into the detector 50 through a bypass pipeline that is a branch of the main pipeline. The gas passed through the detector 50 mixes with the main gas stream in the main pipeline. The detector 50 is placed on the outside of the enclosing cabinet 34 so that the detector 50 can be observed easily by a scrubber operator. The length of the bypass pipeline is long enough to place the detector 50 on a suitable location. In this configuration of the gas scrubber 300, the viewing window for identifying the solid chemical material in the detector 50 does not need to be additionally installed on the surface of the enclosing cabinet 34.

The gas scrubber 400 depicted in FIG. 6 has a camera 42 and a display device 45 connected to the camera. Exhaust gas passed through a canister 40 enters into a detector 50 for passing through a solid chemical material, and discharged to the outside through an exit pipeline of the gas scrubber 400. The camera 42 installed in front of the detector 50 continuously takes pictures of the solid chemical material in the detector 50 through the detection window. The camera 42 preferably takes color pictures, but a camera for taking black/white pictures can also be used. The camera 42 installed in the enclosing cabinet 44 is supported by a camera supporter 43.

Since the camera 42 is connected to a display device 45, the pictures taken by the camera 42 are displayed on the display device 45 in real time. Accordingly, the installation of a viewing window on the surface of the enclosing cabinet 44 for visually identifying the color change is not necessary. By observing the pictures of the solid chemical material on the display device 45, identification of the residual lifetime of the absorbent material can be made. Moreover, the display device 45 can be placed on a remote location from the system, such as a gas scrubber operator can conveniently identify the residual lifetime of the absorbent material from a distance location.

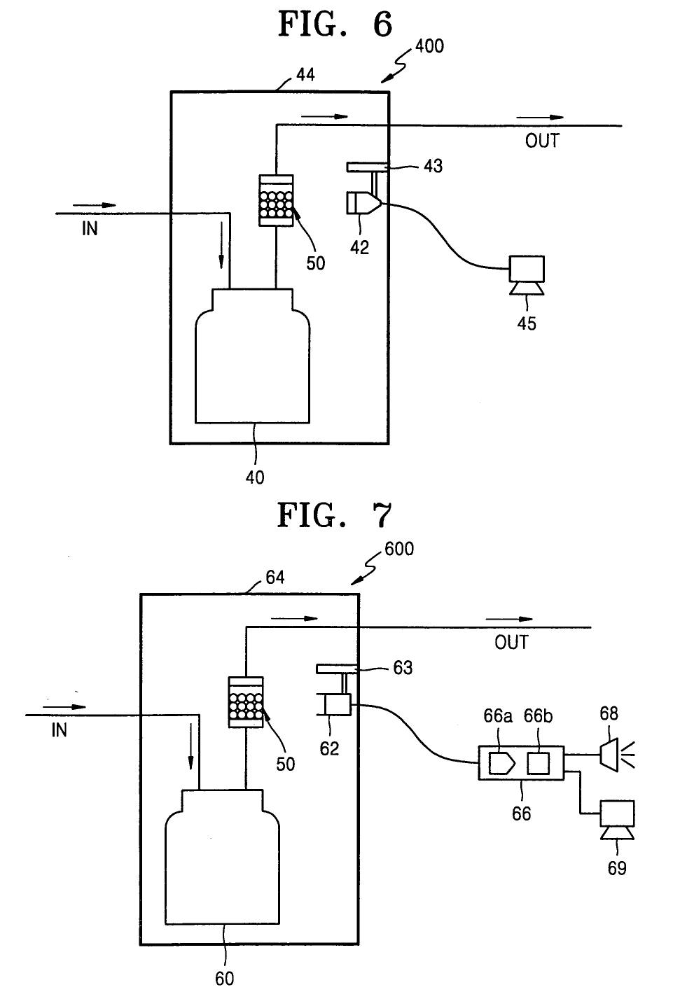

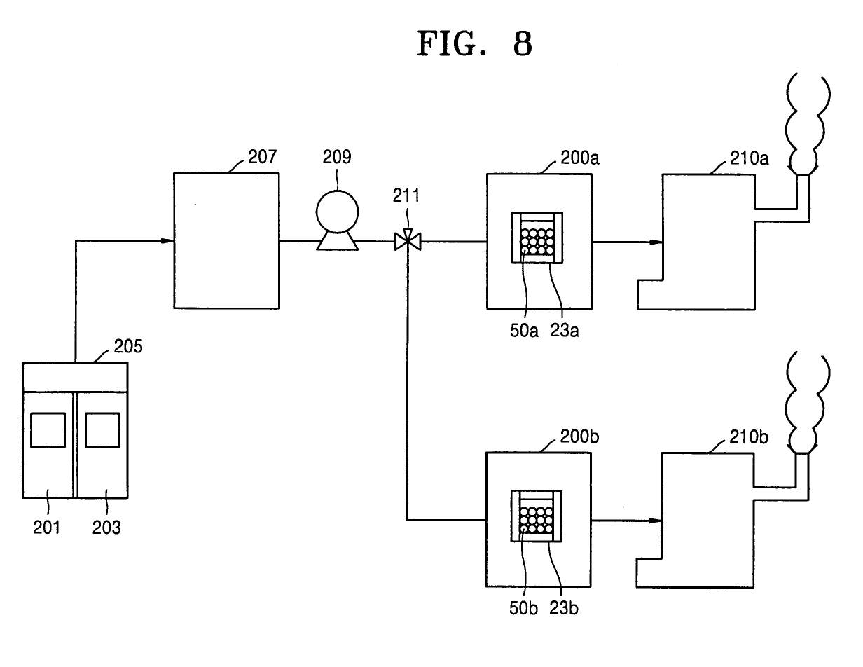

Referring to FIG. 7, a brightness sensor 62 is installed in an enclosing cabinet 64 of a gas scrubber 600. The brightness sensor 62 installed in front of a detector 50 according to an embodiment of the present invention, detects the brightness of a solid chemical material in the detector 50 through a detection window.

As depicted in FIG. 7, the exhaust gas from a process facility (not shown) enters into the gas scrubber 600. The exhaust gas passed through canister 60 in the gas scrubber 600 enters into the detector 50 for being monitored, and leaves the gas scrubber 600 through an exit pipeline. The brightness sensor 62, which is supported by a supporter 63, detects a brightness change of the solid chemical material in the detector 62 through the detection window.

When the absorbing power of the absorbent material is at a normal level, the exhaust gas passed through the absorbent material does not change the color of the solid chemical material in the detector 50. However, if the absorbing power of the absorbent material is lost, the exhaust gas passed through the absorbent material changes the color of the solid chemical material in the detector 50 into a darker color.

The color change of the solid chemical material according to the absorbing power of the absorbent material is detected by the brightness sensor 62 installed in front of the detector 50. The brightness signal obtained by the brightness sensor 62 is transmitted to the control unit 66 that is connected to the brightness sensor 62. The control unit 66 comprises an A/D (alternative/direct) converter 66a. The A/D converter digitizes the brightness signal received from the brightness sensor 62 into a brightness value. The digitized brightness value is then inputted to a microprocessor 66b and is compared to a predetermined value. The predetermined value is a predetermined brightness value for determining the replacement time of the absorbent material. If the measured brightness value is lower than the predetermined value, the absorbing power of the absorbent material is lost. Accordingly, the absorbent material should be replaced.

The control unit 66 is connected to the display device 69 so that the brightness value data is displayed on the display device 69. The brightness value data displayed on the display device is displayed in a digital form or in a form of a bar graph or the like. The display device 69 can display not only the measured brightness value, but also differences between the measured brightness value and the predetermined value. Also, an alarm device 68 is connected to the control unit 66. If the measured brightness value falls below the predetermined value, the control unit 66 sends a signal to the alarm device 68 for transmitting a warning alarm.

When using a gas scrubber according to an embodiment of the present invention, a color change of the solid chemical material is detected through a detection window, which enables continuous confirmation of a residual lifetime and replacement time of an absorbent material, thereby making the management of the gas scrubber easy.

Referring to FIG. 8, a gas supply equipment 205 comprises a process gas supply chamber 201 and a cleaning gas supply chamber 203 which supply the process gas or the cleaning gas separately to a process facility 207. In the process facility 207, a process of CVD, diffusion, or dry etching is conducted by receiving gas from the gas supply equipment 205. On completion of a semiconductor process, the gas supply equipment 205 supplies a cleaning gas to the process facility for cleaning the remaining process gas and powder remained in the process chamber. The exhaust gas, that is, the process gas or the cleaning gas, is maintained at a predetermined pressure by a vacuum pump 209.

The process gas enters into a process gas scrubber 200a after passing through the vacuum pump 209 via a coupling valve 211. The coupling valve 211 opens a designated one of two pipelines connected thereto. Accordingly, by manipulating the coupling valve 211, either automatically or manually, the flow of exhaust gas can be controlled such that the process gas flows only into the process gas scrubber 200a, and the cleaning gas flows only into a cleaning gas scrubber 200b.

The process gas flowing into the process gas scrubber 200a is purified by the process gas scrubber 200a, and is discharged into the atmosphere after a final treatment in a large process gas scrubber 210a. The large process gas scrubber 210a mainly combusts the gas.

When the process is completed, a cleaning gas is supplied to the process facility 207 for cleaning the process chamber of the process facility 207. The cleaning gas enters into the cleaning gas scrubber 200b via the coupling valve 211 after passing through the vacuum pump 209. The cleaning gas enters and is purified in the cleaning gas scrubber 200b. The gas is discharged into the air after final treatment in a large cleaning gas scrubber 210b. The large cleaning gas scrubber 210b mainly combusts the gas.

The exhaust gas passing through the process gas scrubber 200a or the cleaning gas scrubber 200b is purified by passing through a canister installed in the gas scrubber 200a or 200b. In order to identify whether the absorbing power of the absorbent material is at a normal level, a detector 50a or 50b according to an embodiment of the present invention is placed in the exit gas stream of the gas scrubber 200a and 200b. A viewing window 23a or 23b is installed on an enclosing cabinet of the gas scrubber 200a or 200b so as to observe the detector 50a or 50b through the viewing window 23a or 23b. A gas scrubber operator can identify the residual lifetime of absorbent material continuously by observing the color change of a solid chemical material within the detection window, through the detection window of the detector 50a or 50.

According to an embodiment of the present invention, by visually observing the color change of a solid chemical material through a detection window, the residual lifetime and replacement time of an absorbent material can be identified instantly and continuously. Thus, the absorbent material in a gas scrubber can be managed correctly and easily, which enhances the reliability of the gas scrubber.

Also, according to an embodiment of the present invention, the color change of the solid chemical material can be monitored by a display device from a remote place by observing the pictures taken by a camera installed in front of a detection window. In addition, the color change of the solid chemical material can be monitored by a display device from a remote place by observing the brightness data taken by a brightness sensor installed in front of a detection window. Accordingly, a gas scrubber operator can identify the residual lifetime and the replacement time of an absorbent material more conveniently and safely.

Also, since a detector according to an embodiment of the present invention clearly notifies the correct time to replace an absorbent material or canister, the detector significantly reduces the danger of discharging untreated harmful gas into the atmosphere. In other words, the environmental protection from the process gas and cleaning gas can be effectively achieved by using a detector according to an embodiment of the present invention.

Also, the cost of a solid chemical material in a detector according to an embodiment of the present invention is remarkably lower than that of an electrolyte cell for the conventional electrolyte type detector. For a detector according to an embodiment of the present invention, the solid chemical material does not need to be replaced if the gas scrubber has not been operated. The solid chemical material has to be replaced only when the color of the solid chemical material has substantially completely changed due to the loss of lifetime of the absorbent material. Therefore, the maintenance cost of the gas scrubber can be minimized by reducing the installation cost of a detector and the replacement cost of an absorbent material in the detector.

Although the preferred embodiments of the present invention have been described in detail hereinabove, it should be understood that many variations and/or modifications of the basic inventive concepts herein taught, which may appear to those skilled in the art, will still fall within the spirit and scope of the present invention as defined in the appended claims.

1. A detector for identifying an effective lifetime of an absorbent material in a gas scrubber for removing harmful components in an exhaust gas, the detector comprising:
a solid chemical material, the color of which changes when it comes in contact with an untreated exhaust gas due to loss of the absorbing power of the absorbent material; and
a detection window for viewing the solid chemical material for visually identifying the color change of the solid chemical material from a location outside the gas scrubber, and
connecting units on the upper and lower end of the detector.

2. The detector of claim 1, wherein the detection window is made of glass strengthened to withstand the gas pressure passing through the detector.

3. The detector of claim 1, wherein the detection window is cylindrically shaped.

4. The detector of claim 1, wherein the solid chemical material includes a metal component, the color of said metal component changing when the solid chemical material comes in contact with an untreated flammable gas and/or an untreated acidic gas.

5. The detector of claim 1, wherein the solid chemical material comprises a metal oxide.

6. The detector of claim 1, wherein the solid chemical material is a manganese-containing material.

7. The detector of claim 1, wherein the solid chemical material is formed of a plurality of particles that can be visually identified.

8. The detector of claim 7, wherein the particles have an average diameter of about 2.0 mm, an average length of about 7 mm.

9. The detector of claim 8, wherein the particles have an average specific surface of about 170 m²/g, the average specific volume of pores of about 0.9 cc/g, and the average density of about 0.73 g/cc.

10. A gas scrubber comprising:
an apparatus including an absorbent material for purifying a process gas or a cleaning gas; and
a detector for identifying a residual lifetime of the absorbent material, the detector comprising:
a solid chemical material, the color of which changes when it comes in contact with an untreated exhaust gas due to loss of the absorbing power of the absorbent material; and
a detection window for viewing the solid chemical material and for visually identifying the color change of the solid chemical material from outside the gas scrubber.

11. The gas scrubber of claim 10, further comprising an enclosing cabinet within which is disposed said apparatus for purifying said process gas or said cleaning gas and said detector for identifying a residual lifetime of the absorbent material.

12. The gas scrubber of claim 11, wherein the detector is disposed in the enclosing cabinet that comprises a viewing window located on the enclosing cabinet for viewing said color change of the solid chemical material in the detector from outside of the enclosing cabinet.

13. The gas scrubber of claim 11, wherein the detector is disposed outside of the enclosing cabinet.

14. The gas scrubber of claim 10, further comprising a camera for taking pictures of the solid chemical material in the detector.

15. The gas scrubber of claim 14, further comprising a display device connected to the camera, wherein pictures obtained by the camera are exhibited on the display device for visually observing the color change of the solid chemical material.

16. The gas scrubber of claim 10, further comprising a brightness sensor for detecting a brightness of the solid chemical material in the detector.

17. The gas scrubber of claim 16, further comprising a control unit for determining a residual lifetime and a replacement time of the absorbent material by comparing a brightness value, obtained by transmitting a brightness signal from the brightness sensor, with a predetermined value.

18. The gas scrubber of claim 17, further comprising displaying the brightness value data on the display device connected to the control unit.

19. The gas scrubber of claim 17, further comprising an alarm device for transmitting a warning alarm upon receiving a signal from the control unit when the measured brightness value falls below a predetermined value.

20. A method of identifying an effective lifetime of an absorbent material contained in a gas scrubber for purifying exhaust gas, the method comprising:
transferring the exhaust gas passed through the absorbent material in the gas scrubber into a detector; and
identifying a color change of a solid chemical material in the detector through a detection window.

21. The method of claim 20, wherein the color change of the solid chemical material is visually identified through a detection window comprising a viewing window.

22. The method of claim 21, wherein the viewing window is placed in a surface of an enclosing cabinet surrounding the detector.

23. The method of claim 20, wherein the identification of the color change of the solid chemical material through the detection window is made by observing pictures of the solid chemical material taken by a camera installed in the gas scrubber.

24. The method of claim 23, wherein the camera is connected to a display device, and the pictures of the solid chemical material taken by the camera are displayed on the display device.

25. The method of claim 20, wherein the identification of the color change of the solid chemical material is made using a brightness sensor and a control unit connected to the brightness sensor, both of which being disposed in the gas scrubber.

26. The method of claim 25, wherein the control unit converts the brightness signal transmitted from the brightness sensor into a brightness value, and then compares the brightness value to a predetermined value.

27. The method of claim 26, wherein the control unit is connected to a display device, and the brightness value is displayed on the display device.

28. The method of claim 26, wherein the control unit is connected to an alarm device, and the control unit transmits a signal to the alarm device to send a warning alarm when the brightness value falls below a predetermined value.
